(19) United States
(12) Patent Application Publication
(10) Pub. No.: US 2018/0032929 A1
(43) Pub. Date: Feb. 1, 2018

(54) RISK-ADAPTIVE AGILE SOFTWARE DEVELOPMENT

(71) Applicant: CA, Inc., New York, NY (US)

(72) Inventors: Victor Muntes-Mulero, Barcelona (ES); Peter Brian Matthews, Berkhamsted (GB); Smrati Gupta, Barcelona (ES); Jacek Dominiak, Elblag (PL)

(21) Appl. No.: 15/223,522

(22) Filed: Jul. 29, 2016

(51) Int. Cl. G06Q 10/06

(52) U.S. Cl. CPC G06Q 10/0635

(57) ABSTRACT

Techniques are disclosed herein for implementing risk-adaptive system development. A model generator generates a displayed system model comprising displayed system components. A cycle generator determines a risk management cycle comprising a multiple risk management phases. The cycle generator generates a displayed risk management interface which includes multiple displayed risk management phases that are selected and sequenced within the displayed risk management interface based, at least in part, on the determined risk management cycle. The cycle generator further generates component objects that each correspond to a respective one within a set of the system components that have been selected for risk analysis. A display device displays each of the component objects within a respective one of the displayed risk management phases.

### BACKGROUND

The disclosure generally relates to the field of system development processes, and more particularly to tracking risks on a per-component basis during different phases of a risk analysis process that is integrated with a software development lifecycle.

A software development process is typically implemented in and across different developmental phases or stages. The developmental phases are sometimes collectively referred to as a software development lifecycle. The development phases are utilized by programmers and other development team members to design, model, test, construct, and modify software components and multi-component systems. A given development process is typically designed, in part, to meet specified development and performance goals within specified time and resource budgets. The development process for one or more software items may be integrated within the context of a higher-level system development life cycle for a system comprising hardware and/or software components potentially supplied by different development teams.

There are several distinct categories of development processes (sometimes referred to as development models) that may be applied for handling different types of software and system complexities. For example, a waterfall type model implements a sequential, unidirectional development process in which development progress flows “downward” through design, build, test, produce, and maintain phases. So-called spiral development utilizes processes from various different development models based on risk patterns that may be unique to a particular program or multi-program system under development. A spiral model adopts elements of other types of development models (e.g., waterfall, incremental, evolutionary, etc.) based on risk patterns determined by the spiral model.

As software development processes and models become more dynamic, based on continuously changing user-centric requirements, greater flexibility and speed are required for software development. Addressing the need for greater flexibility and speed, agile software development establishes a software development framework in which requirements are addressed and solutions evolve via collaboration across multiple distinct units of the development team. Agile development promotes adaptive planning as well as flexible and rapid response to changes in customer requirements, market conditions, etc. While agile software development techniques provide greater cross-team continuous collaboration for dynamic development, risk management is typically implemented in such processes in a non-integrated manner.

### BRIEF DESCRIPTION OF THE DRAWINGS

Embodiments of the disclosure may be better understood by referencing the accompanying drawings.

FIG. 1 is a block diagram depicting a risk adaptive development subsystem in accordance with some embodiments;

FIG. 2 is a block diagram illustrating a risk management cycle generator in accordance with some embodiments;

FIG. 3 is a flow diagram depicting operations and functions for managing system development in accordance with some embodiments;

FIG. 4 is a flow diagram illustrating operations and functions for operating a displayed risk management interface in accordance with some embodiments;

FIG. 5 is a flow diagram depicting operations and functions for managing movements of components within a displayed risk management interface in accordance with some embodiments; and

FIG. 6 is a block diagram depicting an example computer system that includes a risk-adaptive development system in accordance with some embodiments.

### DESCRIPTION

The description that follows includes example systems, methods, techniques, and program flows that embody aspects of the disclosure. However, it is understood that this disclosure may be practiced without these specific details. In some instances, well-known instruction instances, protocols, structures and techniques have not been shown in detail in order not to obfuscate the description.

Overview

Software development lifecycles are generally designed to maximize program efficacy while avoiding or ameliorating risks such as excessive overhead expenditures, violation of scheduled time-frames, etc. The present disclosure describes systems, devices, components, and methods for integrating risk management techniques and processes within a software development system or subsystem. In one aspect, a software development system includes an application or system architecture generator. As utilized herein, an “application” may refer to a distinct (i.e., independently compiled) application program and or may refer to a collection of multiple application programs and other code constructs such as APIs and libraries. In this manner, the terms application may be utilized synonymously with “system” to designate multiple programs, packages, and scripts that are included within a given system or application architecture design.

In some aspects, a system architecture design may be implemented via a system model comprising multiple system components such as programs, packages, libraries, scripts, etc. Such a system model may represent high, medium, and/or low levels of functionality of a complex system such as a Cloud or multiple Cloud services application comprising multiple components. As utilized herein, a “component” may refer to a “component element” which is a data representation of a system component and is generated as part of a system modeling processing. “Component” may also refer to a corresponding “component object” which is a data representation of a system component corresponding to but distinct from a “component element.” Specifically, a component object is a data representation of a system component that is adapted for use with a displayed risk management interface as described herein.

The disclosed embodiments provide techniques for assessing risks for individual components, sub-sets of components, and for an entire system model on a per-component basis. In some embodiments, system architecture components are processed by a description parser that may utilize components definitions or other information to identify components within a system model that require risk analysis. The description parser may also utilize pre-specified definitions and other information to identify inter-component relationships that may be subject to risk management as described herein.

In some aspects, a management cycle generator receives a set of the components identified as requiring or as otherwise subject to risk analysis during system development. The risk management cycle generator is configured, using any combination of coded software, firmware, and/or hardware, to receive and process data elements representing identified system components. The risk management cycle generator may determine a risk management cycle to be applied to the system model based, at least in part, on one or more risk factors associated with the identified system components. The identified components may be converted or otherwise translated into corresponding data constructs, referred to herein as component objects. Each of the component objects may be input into a corresponding one of multiple displayed risk management phases that form the risk management cycle. The component objects may be inserted and moved between displayed risk management phases such as by graphical user inputs. The risk management cycle generator processes the components, positioning of components, and movements of components to provide a risk-adaptive software development subsystem that detects, identifies, and mitigates risks in an agile development environment.

Example Illustrations

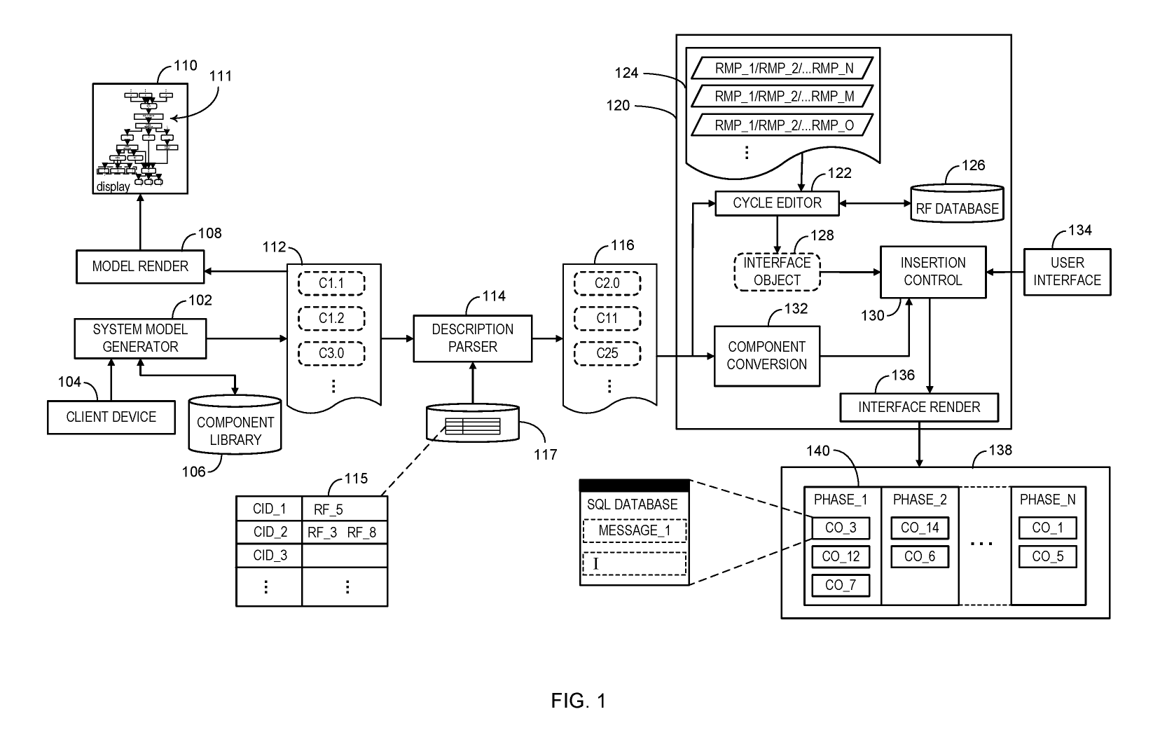

FIG. 1 is a block diagram depicting a risk adaptive development subsystem in accordance with some embodiments. The depicted subsystem includes a system model generator 102 that is configured, using any combination of coded software, firmware, and/or hardware, to define and synthesize constituent components that form a system model. A client device 104 (e.g., a development user station) may access model generator 102 to build or modify a system model. For example, client device 104 may access model generator 102 to specify a new system model 111 to be displayed within a computer display device 110. As part of model specification, the user device 104 may utilize model generator 102 to access a component library 106 that includes listings of component elements and corresponding component descriptions. The system components listed in component library 106 may be defined and structured based on one or more of various modeling languages such as Universal Modeling Language.

Model generator 102 processes input from client device 104 to retrieve component elements and corresponding descriptions from component library 106 to generate a system model file 112 that includes a list component elements C1.1, C1.2, C3.0, etc. The component elements may comprise data constructs that represent system components (e.g., a document server, API, etc.) and may also include constructs representing communication protocols or other connectivity features between system components. Model render unit 108 receives system model file 112 as input and displays the components and components' connectivity within the displayed system model 111 accordingly.

In some embodiments, the system model file 112 is also be sent to and received by a description parser 114 that is configured, using any combination of coded software, firmware, and/or hardware, to identify individual components and connections. Description parser 114 may first identify each of the components and connections described by the corresponding component elements. Each of the component elements C1.1, C1.2, and C3.0, may include a specified alphanumeric component ID associated with component description data. For example, component element C1.2 include component ID “DOCUMENT SERVER.” Description parser 114 may utilize the component IDs as indices to access a risk factors table 115 stored within storage device 117. Risk factors table 115 includes row-wise entries that each associates one or more of the component element identifiers with a quantitative and/or qualitative risk factor value or descriptor. For instance, the first entry of risk factor table 115 associates a component ID, CID_1, with a risk factor ID, RF_5, the second entry associates one component ID, CID_2, with two risk factor IDs, RF_3 and RF_8, and the third entry indicates that no risk factors are associated with CID 3.

In some embodiments, description parser 114 selects a subset of the identified components to be input to and processed by a risk management cycle generator 120. The selection of component elements may be based, at least in part, on risk factor data associated with the component elements within risk factor table 115. For each component ID in a system model corresponding to an entry within table 115, description parser 114 determines whether to select the corresponding component element to be included in a component risk file 116 in accordance with the associated risk factor(s). In this manner, component risk file 116 includes entries for a subset of 0 to n of the n component elements included in system model file 112. For example, component risk file 116 is depicted as including component elements C2.0, C11, C25, etc.

Component risk file 116 is transmitted to and received as input by risk management cycle generator 120, which includes several components including a cycle editor 122 and a component conversion unit 132. Cycle editor 122 is configured, using any combination of coded software, firmware, and/or hardware, to identify, construct, synthesize, or otherwise determine a risk management cycle having multiple risk management phases. The determined risk management cycle is utilized to generate a risk management interface object 128 that may be displayed by an interface render module 136 on a display device 138. Cycle editor 122 may determine the risk management cycle as a sequence of phases that themselves are selected or otherwise determined and are further mutually sequenced based, at least in part, on input from a cycle templates file 124 and a component risk factor database 126.

Cycle templates file 124 includes entries that specify distinct templates each comprising multiple phases having a specified sequence. For instance, the first depicted entry in cycle templates file 124 specifies a sequence of risk management phases beginning with risk management phase 1 (RMP_1) and concluding with RMP_N. Cycle editor 122 may initially select and/or modify one of the cycle template based, at least in part, on a collective assessment of component-specific risks factors that may be specified within risk factor database 126.

Having determined a risk management cycle, cycle editor 122 generates an interface object 128, which includes multiple risk management phase objects (not depicted) that correspond to the phases and sequencing of the determined management cycle. Interface object 128 may comprise data and program code and be displayable such as via rendering by interface render module 136 within display device 138. As shown in FIG. 1, interface object 128 is received as input by an insertion control unit 130, which is configured, using any combination of coded software, firmware, and/or hardware, to determine the manner in which objects representing system components (i.e., component objects) are to be displayed and otherwise processed within the displayed risk management interface 140. A user interface 134 may be utilized to send instructions to insertion control unit 130 to modify interface object 128 such by adding or removing a risk management phase from the cycle.

Insertion control unit 130 also receives as input component objects (not depicted) that are generated by component conversion unit 132. In the depicted embodiment, conversion unit 132 receives as input and processes the component element entries within component risk file 116. More particularly, conversion module 132 may generate displayable data objects that include some template-based features that are common for all of the generate component objects and further include component-specific features. For instance, conversion module 132 may insert a component ID such as the ID “SQL DATABASE” included within the component object, CO_3, displayed within the displayed PHASE_1 object.

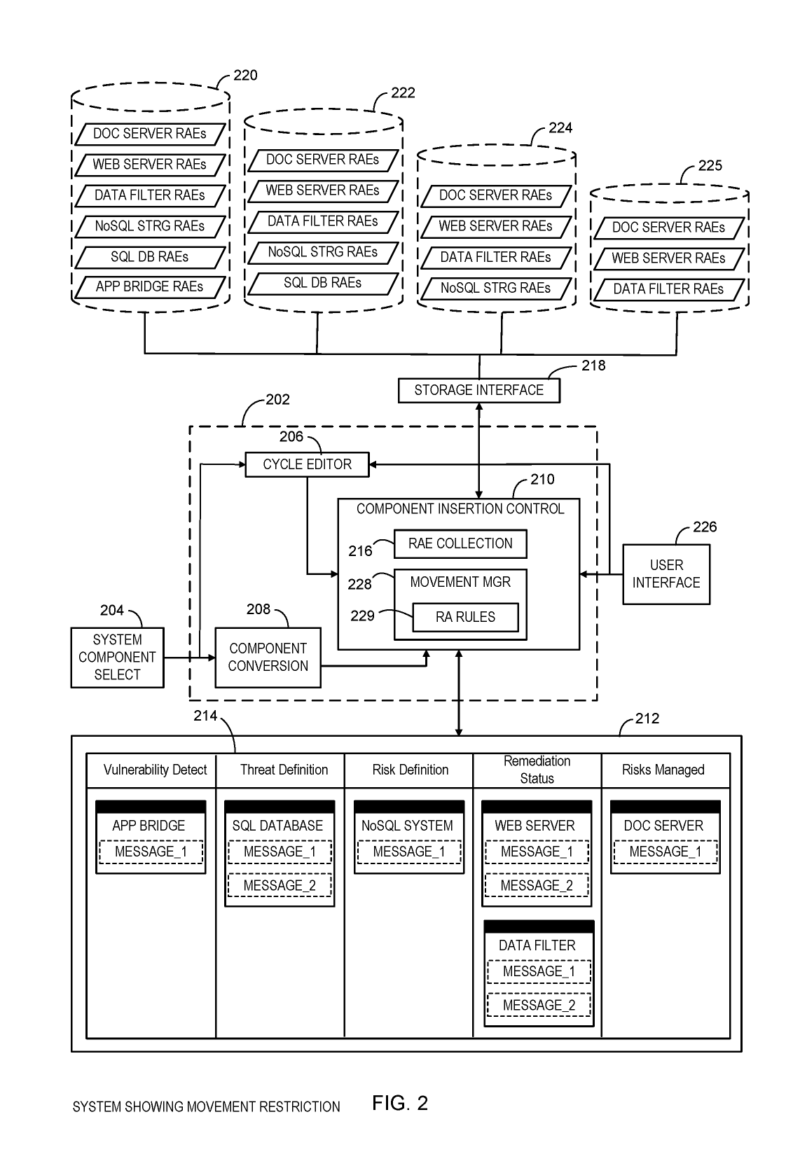

The development subsystem components, such as risk management cycle generator 120, may further be configured, using any combination of coded software, firmware, and/or hardware, to dynamically manage the display of system components. FIG. 2 is a block diagram illustrating a risk management cycle generator and other components that are configured to manage interface and component display in accordance with some embodiments. As shown, a risk management cycle generator 202 includes a cycle editor 206 and a component conversion unit 208 that each receive selected component elements from a system component select unit 204. Cycle editor 206 and conversion unit 208 may receive one or more files containing entries that associate component IDs with corresponding component description information.

Based on the component element input and other information, cycle editor 206 generates management interface object data that is input to a component insertion control unit 210. For instance, cycle editor 206 may access cycle template data and/or component risk factor data from respective files as shown in FIG. 1. In addition or alternatively, cycle editor 206 may receive cycle phase data via a user input interface 226 that may be processed by cycle editor 206 to generate or modify the risk management interface object data. The risk management object data is rendered within a display device 212 as a risk management interface object 214 comprising five displayed phase objects, VULNERABILITY DETECT, THREAT DEFINITION, RISK DEFINITION, REMEDIATION STATUS, and RISKS MANAGED. In some embodiments, risk management interface object 214 may represent a Kanban-style board utilized by members of a development team to visually assess the status and progress of system components in a risk analysis process modeled by the constituent risk management phases.

In addition to the management interface object data from cycle editor 206, insertion control unit 210 receives component object data from component conversion unit 208. For instance, component conversion unit 208 may generate an object data construct for each of the input selected component elements and output a set of corresponding component objects to insertion control unit 210. In the depicted example, component conversion unit 208 generates six component objects that are each displayed within a respective one of the five phase objects within management interface object 214. The displayed component objects include an APP BRIDGE object displayed in the VULNERABILITY DETECT phase object, an SQL DATABASE object displayed in the THREAT DEFINITION phase object, a NoSQL SYSTEM object displayed in the RISK DEFINITION phase object, WEB SERVER and DATA FILTER objects both stored in the REMEDIATION STATUS phase object, and a DOC SERVER object displayed in the RISKS MANAGED phase object. In some embodiments, movement of the component objects between phases may be performed based on and in response to user input such as a command line instruction or as a graphical user input such as a drag and drop operation. In other embodiments, the component objects may be moved between displayed phases based on and in response to background risk analysis processing.

In the depicted embodiment, insertion control unit 210 includes, among other components, a risk analysis element (RAE) collection unit 216 and a movement manager 228. RAE collection unit 216 is configured, using any combination of coded software, firmware, and/or hardware, to identify component objects that are displayed in or otherwise associated with each of the risk management phases. Upon initial generation of a risk management interface, RAE collection unit 216 may identify each of the multiple constituent phase objects and determine that some or all of the system component objects are associated with (e.g., displayed within) the first of the sequenced phases. In the depicted embodiment, for example, RAE collection unit 216 may determine that all of the system component objects are initially displayed within the VULNERABILITY DETECT phase object.

As the component objects traverse the displayed phase objects, RAE collection unit 216 is further configured to monitor each of the phases to identify which object components are displayed therein. For example, FIG. 2 shows a displayed state of risk management interface 214 in which the APP BRIDGE component remains in the initial, VULNERABILITY DETECT, phase while each of the others of the component objects have been moved to a respective one of the subsequent displayed phases. For each phase object, RAE collection unit 216 parses the message content or other data within each of the presently contained component objects to identify risk analysis elements contained therein. Risk analysis elements may comprise an entire message or a portion of a message that has been added to a component object. For example, a risk analysis element for the NoSQL SYSTEM object within the RISK DEFINITION object may comprise the MESSAGE_1 text string “storing a log of credit card user transactions.”

RAE collection unit 216 copies the risk analysis elements for each of the component objects in each of the phase objects and transmits the risk analysis elements to a storage interface 218. Storage interface 218 stores the risk analysis elements to one of a set of collection objects 220, 222, 224, and 225. Each of collection objects 220, 222, 224, and 225 corresponds to a respective one of the displayed risk management phases. In the depicted embodiment, collection object 220 corresponds to the VULNERABILITY DETECT object, collection object 222 corresponds to the THREAT DEFINITION object, collection object 224 corresponds to the RISK DEFINITION object, and collection object 225 corresponds to the REMEDIATION STATUS object. RAE collection unit 216 may include a table or other data structure that associates identifiers (e.g., filenames) for each of collection objects 220, 222, 224, and 225 with the corresponding displayed risk management phase.

As shown in FIG. 2, the risk analysis elements are incrementally stored and maintained within the collection objects as component objects are moved from one phase to the next. Consider, for instance, the depicted state in which the APP BRIDGE object remains in the first phase object and the other component objects have progressed to others of the subsequent phases as depicted within risk management interface 214. As shown, RAE collection unit 216 has identified and stored risk analysis elements for all six of the component objects within collection object 220. The risk analysis elements within collection object 220 were identified and stored by RAE collection unit 216 during the respective periods in which each of the components were originally positioned within the VULNERABILITY DETECT phase. Continuing with the example depicted state of risk management interface 214, the risk analysis elements for component objects that are currently in or were previously positioned within the THREAT DEFINITION phase object are stored within collection object 222. Similarly, collection object 225 includes only risk analysis elements for the three component objects, DOC SERVER, WEB SERVER, and DATA FILTER, which have traversed to or moved beyond the REMEDIATION STATUS phase object.

As depicted, each of the risk analysis elements corresponds to a respective one of the component objects and is stored in a collection object that uniquely corresponds to one of the displayed risk management phases. In this manner, the risk analysis elements stored within the collection objects are both component and phase specific. To facilitate collection of the risk analysis elements as components are positioned in and moved between phases, insertion control unit 210 may be further configured to receive graphical user input signals to detect movement of the component objects between the displayed phases. For example, when insertion control unit 210 detects that the NoSQL SYSTEM object has moved from the THREAT DEFINITION phase to the RISK DEFINITION phase, RAE collection unit 216 may allocate a NoSQL SYSTEM collection file within collection object 224. The collection file may be accessed to store risk analysis elements collected from the NoSQL SYSTEM component (e.g., messages entered by users) during the period in which the NoSQL SYSTEM remains in the RISK DEFINITION phase.

The risk analysis element data stored within collection objects 220, 222, 224, and 225 includes content (e.g., message specifying a particular component vulnerability) that is both component and phase specific. Such data may be utilized for various risk management analysis purposes including controlling or otherwise managing movements of component objects between the displayed phase objects. In response to insertion control unit 210 detecting an attempted movement of a component object between phase objects, a call may be sent to movement manager 228 indicating the detected movement or positioning. In response to the call indicating an attempted movement of the component object, movement manager 228 generates a risk condition query that may be based, at least in part, on a selected one of risk analysis rules 229. For example, movement manager 228 may receive a call to generate a risk condition query in response to detection of the WEB SERVER component object being moved from the REMEDIATION STATUS phase object to the RISKS MANAGED phase object. To generate the risk condition query, movement manager 228 selects one of risk analysis rules 229 to be applied in determining whether to reject or otherwise restrict the movement or attempted movement. In some embodiments, the selected risk analysis rule defines a risk condition that is dependent on a specified relation between a risk analysis element in the origin phase (e.g., REMEDIATION STATUS) and a risk analysis element in a phase preceding the origin phase (e.g., RISK DEFINITION). Continuing with the example, the risk analysis elements for the WEB SERVER component stored within collection object 224 may comprise messages that each specify a defined risk. Furthermore, the risk analysis elements for the WEB SERVER component stored within collection object 225 may comprise messages that each specify a remediation status for one or more risks. In this case, movement manager 228 may select a risk analysis rule that determines whether collection objection 225 includes a WEB SERVER risk analysis element (remediation status) that, based on the rule, adequately addresses each and all of the defined risks specified by collection object 224 for the WEB SERVER component.

In other examples, movement manager 228 may select a risk analysis rule that determines whether to reject or otherwise restrict a component movement from the RISK DEFINITION phase to the REMEDIATION STATUS phase. For instance, in response to determining that RISK DEFINITION is the origin phase, movement manager 228 may select a rule that defines the movement acceptance condition as depending on whether a risk definition RAE has been specified for each of the specified threat definition RAEs.

Having selected a risk analysis rule in association with the origin phase object or otherwise, movement manager 228 generates and sends a risk condition query to storage interface 218. The query may specify the collections objects from which data is to be retrieved and also may specify individual data objects (e.g., files) that are associated with component object IDs. During query execution, movement manager 228 retrieves a set of one or more risk analysis elements from the one of the collection objects that corresponds to the origin phase object. Movement manager 228 further retrieves a set of one or more risk analysis elements from one or more of the collection objects that correspond to phase object(s) that precede the origin phase object. Movement manager 228 processes the retrieved risk analysis elements in accordance with the selected risk analysis rule to determine whether the risk condition defined by the rule has been detected based on the risk analysis element data. If the risk condition is detected (e.g., one of the threat definition RAEs lacks a corresponding risk definition RAE) movement manager 228 issues a call to a display manager to implement a movement rejection action. In some embodiments, the movement rejection action may entail the display manager displaying a warning message in association with risk management interface 214. In some embodiments, the movement rejection action may entail the display manager preventing the movement of the displayed component object.

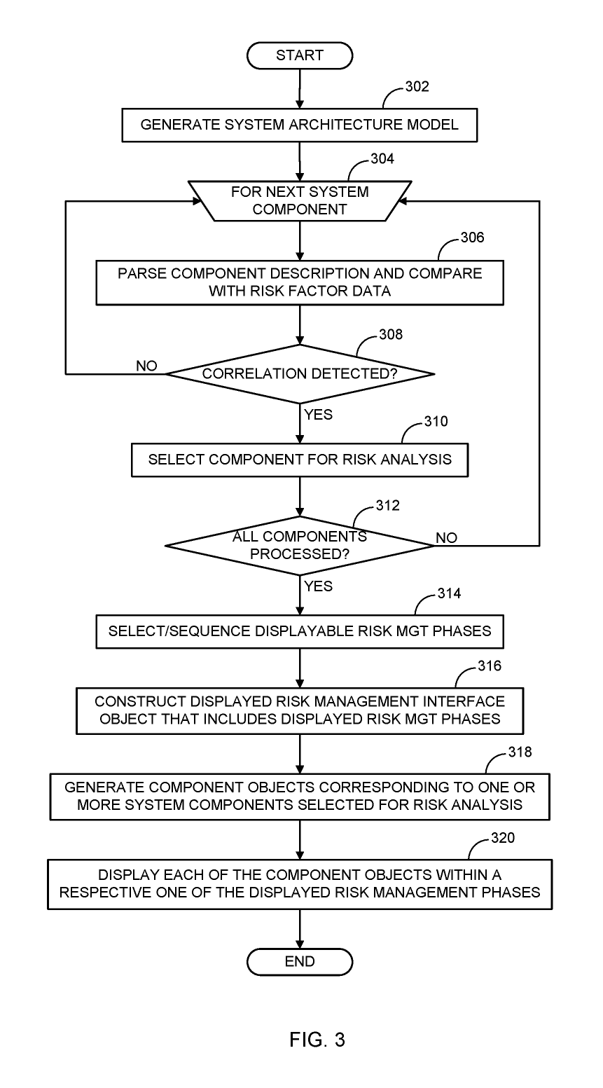

FIG. 3 is a flow diagram depicting operations and functions for implementing risk-adaptive system development in accordance with some embodiments. The operations and functions depicted in FIG. 3 may be implemented by one or more of the devices and components illustrated and described with reference to FIGS. 1 and 2. The process begins as shown at block 302 with model generator generating a system architecture model. The system model may represent a software system design that includes multiple component elements that may represent full software applications and/or subcomponents of software applications. In some embodiments, the component elements are generated using programming language constructs such as UML objects. The component elements and interconnections among the elements may be displayed by a model rendering unit such that developers can efficiently visually evaluate the composition of the system model.

During or following construction or modification of the displayed system model, each of the component elements are received as input by a description parser (block 304). For each component element, the description parser parses descriptive content and compares the content with risk factor data (step 306) to determine whether or not to select the component for risk analysis. For example, the description parser may identify the component element representing an SQL database based on parsed object data (e.g., object ID). The description parser may then compare this data with risk factor data by utilizing “SQL,” “DATABASE,” and/or “SQL DATABASE” as an index key in a risk factor file that associates component identifiers with corresponding risk factors. The comparison may result in the description parser determining a correlation between the component description and one or more specified risk factors. For instance, a correlation may be detected in response to determining that the component ID “SQL DATABASE” is associated within a risk factor file with one or more specified risk factors.

In response to detecting no correlation at block 308, process control returns to block 304 for processing of a next component element in the model. In response to detecting a correlation at block 308, the description parser selects the component element for analysis such as by entering the component element description in a component risk file (block 310). Processing of each of the component elements in the foregoing manner continues until all components have been processed as determined at block 312 and control passes to block 314 with a risk management cycle generator generating a displayable risk management interface object. The risk management interface object includes multiple displayed risk management phase objects that are designated by a phase identifier. For example, the phase objects depicted in FIG. 2 are designated by phase identifiers VULNERABILITY DETECT, THREAT DEFINITION, RISK DEFINITION, REMEDIATION STATUS, and RISKS MANAGED. As explained with reference to FIG. 1, the cycle generator may select the phase objects from a cycle templates file based, at least in part, on data from a risk factor database.

At block 316, a cycle editor within the cycle generator generates the risk management interface object comprising the selected and sequenced phase objects and outputs the risk management interface object to an insertion control unit. The component risk file generated at blocks 304 through 312 is input to and processed by the cycle generator. The cycle generator includes a component conversion unit that generate component objects that each correspond to a respective one of the component elements included in the component risk file (block 318). At block 320, each of the component objects are displayed within a respective one of the displayed risk management phases within the risk management interface.

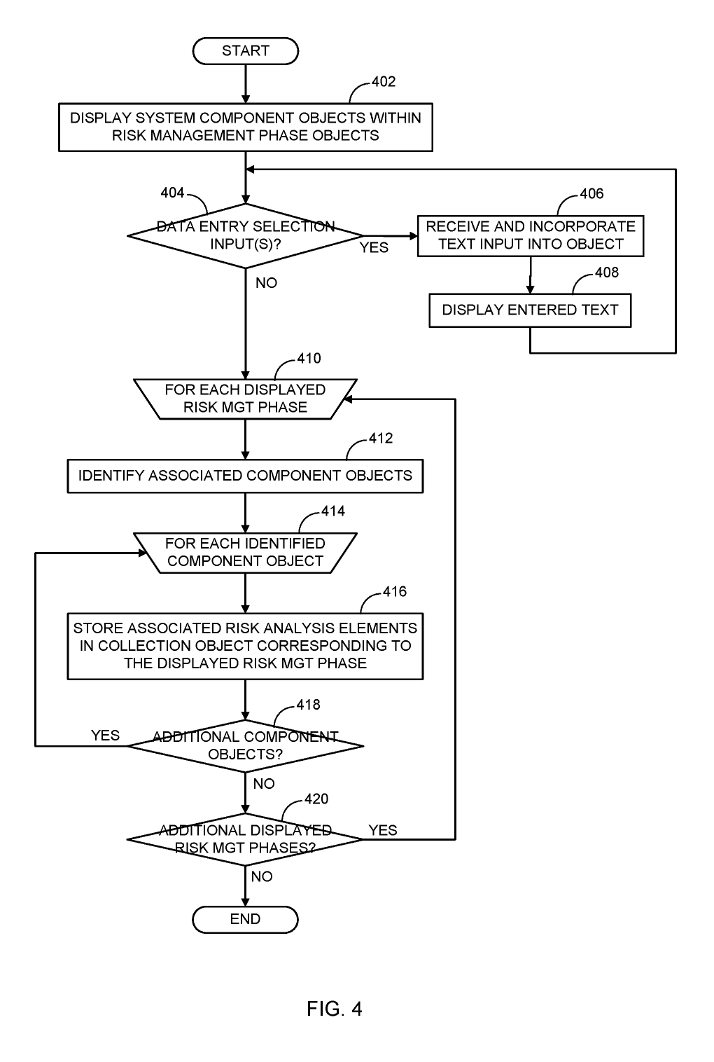

FIG. 4 is a flow diagram illustrating operations and functions for managing a displayed risk management interface in accordance with some embodiments. The operations and functions depicted in FIG. 4 may be implemented by one or more of the devices and components illustrated and described with reference to FIGS. 1 and 2. The process begins as shown at block 402 with a display controller displaying each of multiple system component objects within a respective one multiple displayed risk management phase objects. The phase objects and component objects have been generated by a cycle generator that includes an insertion control unit that receives user input such as via a graphical interface pointing device. In response to or otherwise following a detected selection of one of the displayed component objects (block 404), the insertion control unit receives and incorporates text input to be displayed in association with the selected object. For instance, if a WEB SERVER component is selected as it is displayed within a REMEDIATION STATUS phase object, the insertion control unit may issue a call to a display controller to display a text input object into which a user may enter a text string message. Following entry, the text string is incorporated into and displayed within the component object (block 408). In this manner, developers can enter risk-related information into component objects and this information is further associated with a particular risk management phase by virtue of the positioning of the component object at the time of entry.

The depicted embodiment further includes operations and functions for collecting and storing the messages and other risk-related information associated with a component object as it traverses the cycle phases. It should be noted that while the foregoing and the following blocks are depicted in relative sequence, the operations and functions for entering data within components and collecting and storing the data may be performed concurrently and in a continuous manner. At blocks 410 and 412 an RAE collection unit identifies component objects that are displayed within the phase objects. For each component object, the RAE collection unit collects risk analysis elements incorporated in or otherwise associated with the component object (block 414). At block 416, the RAE collection unit stores the collected risk analysis elements with a collection object that uniquely corresponds to the phase object in which the component object is currently displayed. The RAE collection unit may perform the collection and storage operations for each of the displayed component objects in an individual instance or batched manner. For example, the RAE collection unit may respond individually to each new text entry (blocks 406 and 408) by collecting and storing the text entry as a risk analysis element. In addition or alternatively, the RAE collection unit may respond to an instruction to collect and store risk analysis elements for all components or a subset of the components. In such an embodiment, the process continues for each component (block 418) within each displayed phase (block 420).

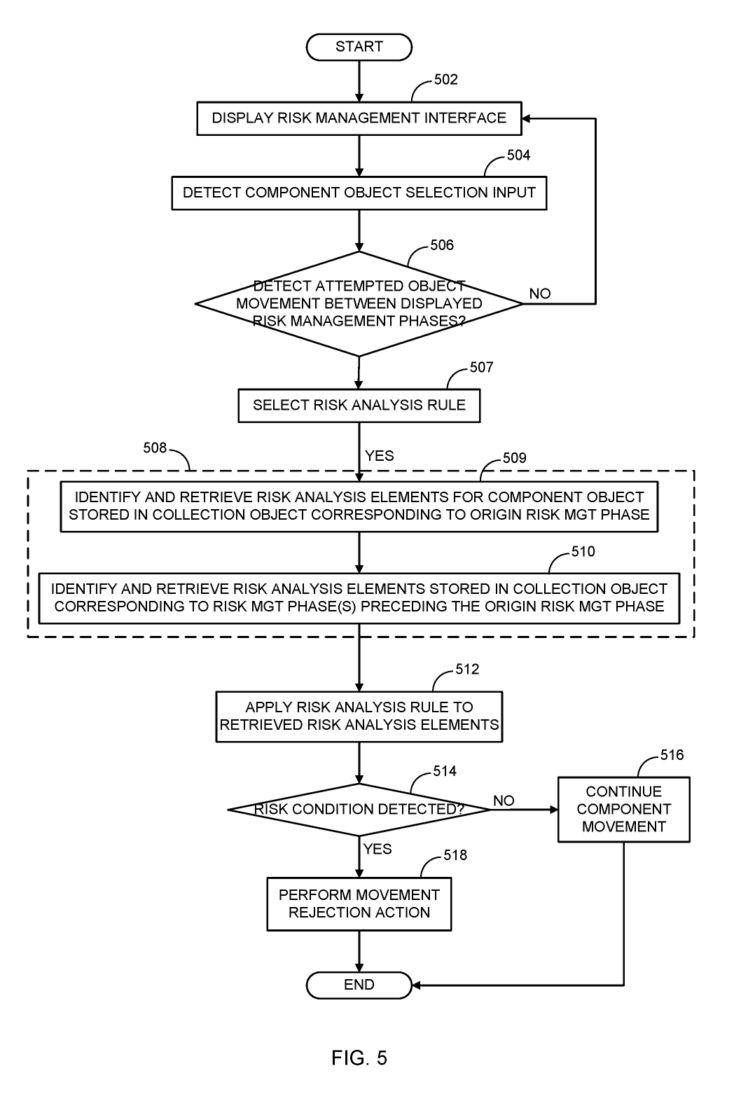

FIG. 5 is a flow diagram depicting operations and functions for managing movements of components within a displayed risk management interface in accordance with some embodiments. The operations and functions depicted in FIG. 5 may be implemented by one or more of the devices and components illustrated and described with reference to FIGS. 1 and 2. The process begins as shown at block 502 with a cycle generator in combination with a display controller displaying a risk management interface object that comprises a sequence of displayed phase objects in which component objects are displayed. At block 504, an insertion control unit within the cycle generator detects a user interface input selection associated with one of the component objects. The insertion further determines whether the input selection constitutes a movement or attempted movement of the component object from one phase object to another (block 506). As described with reference to FIG. 4, the input selection may be a text entry object selection, such as via double clicking on the component object. An input selection associated with movement of the component object may comprise, for example, a drag and drop operation.

In response to detecting an attempted movement of the component object between phase objects, a movement manager within the insertion control unit selects a risk analysis rule (block 507). In some embodiments, the risk analysis rule defines a risk condition that depends on a specified relation between risk analysis element for the same component but across different phases. The risk analysis rule may be selected from among multiple risk analysis rules that, as a set, are implemented in the cycle generator configuration based on the identities of one or more of the phase objects.

In further response to detecting an attempted movement of the component object and following selection of a risk analysis rule, the movement manager generate and executes a risk condition query at superblock 508. The risk condition query may include one or more data read requests issued to a storage system in which multiple collection objects corresponding to displayed phase objects are maintained. The read request(s) constituting the risk condition query may be determined, at least in part, based on the selected risk analysis rule. For example, the risk analysis rule may define a risk condition as a condition in which there is a quantitative or qualitative discrepancy between risk analysis elements for a common component but between different phases. Furthermore, the rule may specify the condition as being determined between the origin phase object (i.e., the phase object from which the component has been moved or been attempted to be moved to a target phase object) and a phase object preceding the origin phase object. As shown beginning at block 509, execution of the risk condition query includes identifying and retrieving risk analysis elements for the component object that are stored in a collection object corresponding to the origin phase object. At block 510, the movement manager completes execution of the risk condition query by identifying and retrieving risk analysis elements for the same component object but that are stored in a collection object corresponding to the to a phase object that preceded the origin phase object.

Having read or otherwise retrieved the risk analysis elements, the movement manager applies the risk analysis rule to the risk analysis elements (block 512). In response to detecting a risk condition defined by the rule as a result of applying the rule to the risk analysis elements (block 514), the movement manager issues a program call to implement a movement rejection action (block 518). For example, the movement manager may instruct a display manager to display a warning message indicating the risk condition defined by the risk analysis rule. In some embodiments, the movement rejection action may entail preventing movement of the displayed component object or returning the displayed component object to be displayed in the origin phase object. If application of the risk analysis rule to the retrieved risk analysis elements fails to meet the defined risk condition, the component movement is accepted (block 516).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

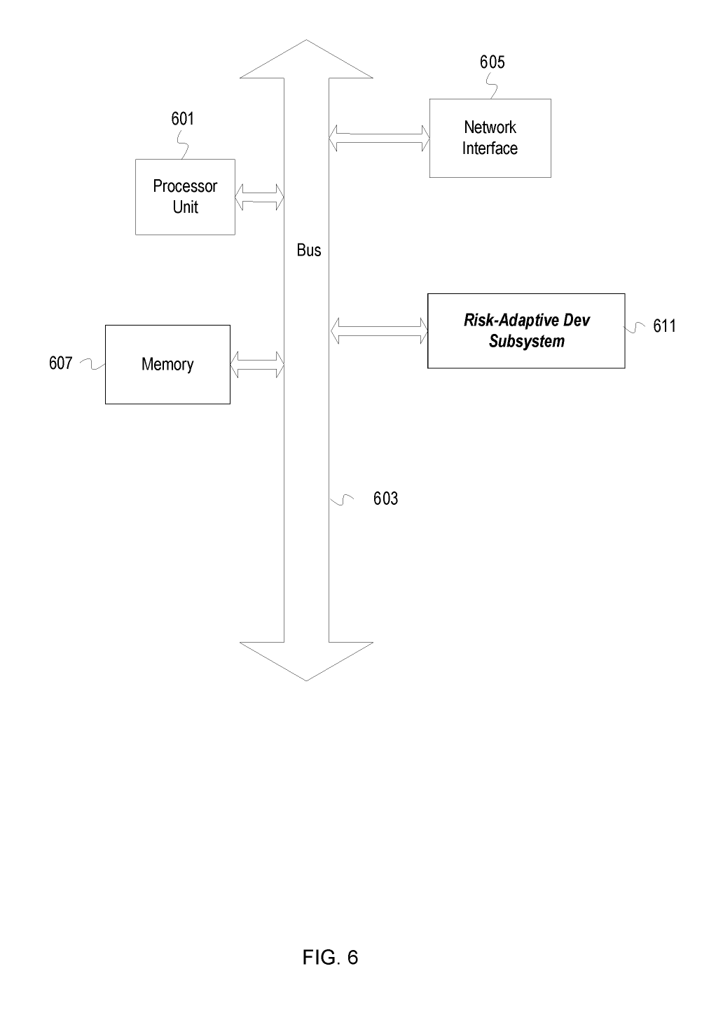

FIG. 6 depicts an example computer system that implements risk-adaptive system development in accordance with an embodiment. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a risk-adaptive development subsystem 611. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for implementing risk-adaptive system development as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method for managing system development, said method comprising:
displaying, in a first user interface, a system model comprising system components;
determining a risk management cycle comprising a plurality of risk management phases;
displaying, in a risk management interface, risk management phases that are selected and sequenced within the risk management interface based, at least in part, on the determined risk management cycle;
generating component objects that each correspond to a respective one within a set of the system components that have been selected for risk analysis; and
displaying each of the component objects within a respective one of the displayed risk management phases.

2. The method of claim 1, further comprising, in response to a user input selection of one of the component objects, receiving and incorporating text input to be displayed by the selected component object.

3. The method of claim 1, further comprising selecting one or more of the management phases to be included in the risk management cycle based, at least in part, on the selected set of system components.

4. The method of claim 1, further comprising:
for each of at least two of the risk management phases,
identifying component objects that are associated with the risk management phase; and
for each of the identified component objects, storing risk analysis elements associated with the identified component object within a collection object that uniquely corresponds to the risk management phase.

5. The method of claim 4, wherein the risk analysis elements include risk management data entered via a user interface into corresponding component objects.

6. The method of claim 4, further comprising, in response to detecting an attempted movement of a first component object from a displayed risk management phase to a second risk management phase:
generating a risk condition query based, at least in part, on a risk analysis rule associated with the first risk management phase; and
executing the risk condition query including,
retrieving, from a first collection object corresponding to the first risk management phase, a first set of risk analysis elements associated with the first component object; and
retrieving, from a second collection object corresponding to a risk management phase that precedes the first risk management phase, a second set of risk analysis elements associated with the first component object.

7. The method of claim 6, further comprising:
processing the retrieved risk analysis elements in accordance with the risk analysis rule that is associated with the first displayed risk management phase and the preceding displayed risk management phase;
identifying a risk condition based, at least in part, on a result of said processing the retrieved risk analysis elements; and
implementing a movement rejection action in response to said identifying the risk condition.

8. The method of claim 7, wherein the risk analysis rule defines a risk condition that depends on a specified relation between at least one of the risk analysis elements that is associated with the first component object and the first risk management phase and at least one of the risk analysis elements that is associated with the first component object and the preceding risk management phase.

9. The method of claim 1, wherein said determining a risk management cycle comprises:
determining risk factors associated with one or more of the set of the system components; and
selecting phases to be included based, at least in part, on the determined risk factors.

10. The method of claim 9, further comprising:
determining a relation between at least two of the risk factors; and
selecting phases to be included in the risk management cycle based, at least in part, on the determined relation between at least two of the risk factors.

11. The method of claim 10, wherein said determining a relation between the at least two of the risk factors comprises determining a causal relation between the at least two of the risk factors, said method further comprising sequencing two or more of the selected phases based, at least in part, on the determined causal relation.

12. One or non-transitory more machine-readable storage media having program code for managing system development stored therein, the program code configured to:
display, in a first user interface, a system model comprising system components;
determine a risk management cycle comprising a plurality of risk management phases;
display, in a risk management interface, risk management phases that are selected and sequenced within the risk management interface based, at least in part, on the determined risk management cycle;
generate component objects that each correspond to a respective one within a set of the system components that have been selected for risk analysis; and
display each of the component objects within a respective one of the displayed risk management phases.

13. The machine-readable storage media of claim 12, further comprising, in response to a user input selection of one of the component objects, receiving and incorporating text input to be displayed by the selected component object.

14. The machine-readable storage media of claim 12, further comprising selecting one or more of the management phases to be included in the risk management cycle based, at least in part, on the selected set of system components.

15. The machine-readable storage media of claim 12, further comprising:
for each of at least two of the risk management phases,
identifying component objects that are associated with the risk management phase; and
for each of the identified component objects, storing risk analysis elements associated with the identified component object within a collection object that uniquely corresponds to the risk management phase.

16. The machine-readable storage media of claim 15, wherein the risk analysis elements include risk management data entered via a user interface into corresponding component objects.

17. The machine-readable storage media of claim 15, further comprising, in response to detecting an attempted movement of a first component object from a displayed risk management phase to a second risk management phase:
generating a risk condition query based, at least in part, on a risk analysis rule associated with the first risk management phase; and
executing the risk condition query including,
retrieving, from a first collection object corresponding to the first risk management phase, a first set of risk analysis elements associated with the first component object; and
retrieving, from a second collection object corresponding to a risk management phase that precedes the first risk management phase, a second set of risk analysis elements associated with the first component object.

18. The machine-readable storage media of claim 17, further comprising:
processing the retrieved risk analysis elements in accordance with the risk analysis rule that is associated with the first displayed risk management phase and the preceding displayed risk management phase;
identifying a risk condition based, at least in part, on a result of said processing the retrieved risk analysis elements; and
implementing a movement rejection action in response to said identifying the risk condition.

19. The machine-readable storage media of claim 18, wherein the risk analysis rule defines a risk condition that depends on a specified relation between at least one of the risk analysis elements that is associated with the first component object and the first risk management phase and at least one of the risk analysis elements that is associated with the first component object and the preceding risk management phase.

20. An apparatus comprising:
a processor; and
a machine-readable medium having program code executable by the processor to cause the apparatus to,
display, in a first user interface, a system model comprising system components;
determine a risk management cycle comprising a plurality of risk management phases;
display, in a risk management interface, risk management phases that are selected and sequenced within the risk management interface based, at least in part, on the determined risk management cycle;
generate component objects that each correspond to a respective one within a set of the system components that have been selected for risk analysis; and
display each of the component objects within a respective one of the displayed risk management phases.
